(19) United States
(12) Patent Application Publication
(10) Pub. No.: US 2008/0158113 A1
(43) Pub. Date: Jul. 3, 2008

(54) DISPLAY DEVICE, DISPLAY SYSTEM, AND COMPUTER-READABLE RECORDING MEDIUM IN WHICH LUMINANCE CONTROL PROGRAM IS STORED

(75) Inventor: Koji OZAWA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/876,096

(22) Filed: Oct. 22, 2007

(30) Foreign Application Priority Data
Dec. 27, 2006 (JP) 2006-352002

(51) Int. Cl. G09G 3/30

(52) U.S. Cl. 345/77

(57) ABSTRACT

To improve the convenience of users and facilitate a change into a luminance control mode high in power save effect, the display device includes a luminance control unit for controlling a luminance of the display unit in a luminance control mode selected from a first luminance control mode in which the luminance of the display unit is changed according to the ambient luminance detected by the sensor, a second luminance control mode in which the luminance is maintained at a predetermined luminance previously determined and a third luminance control mode in which the luminance is maintained at a minimum luminance; a first operating unit being operated to change the luminance control mode; and a change controlling unit for changing the luminance control mode, in which the luminance control unit currently controls the luminance of the display unit, responsive to operating the first operating unit.

### BACKGROUND OF THE INVENTION

1. Field of the Invention

The present invention relates to a technique to adjust the luminance (brightness) of a display, such as a LCD (Liquid Crystal Display), incorporated in a display device.

2. Description of the Related Art

In a conventional display device including a display such as a liquid crystal display, a user intending to change the luminance (brightness) of the display to a preferable luminance that user feels it comfortable to see needs to operate a number of operation buttons installed on the display device with reference to an OSD (On Screen Display) to adjust the luminance.

Some recent liquid crystal display devices and liquid crystal televisions incorporate brightness sensors and have a function for automatically adjusting (the luminance of) the displays to a suitable luminance according to the ambient brightness detected (measured) by such sensors.

Conventional liquid crystal display devices and the like however require OSD operations to cancel the automatic adjustment, so that users have to sequentially operate one or more operation buttons a number of times.

As a solution, there have been proposed techniques to switch between automatic adjustment and non-automatic operation by operating a single operating unit (e.g., below Patent References 1 and 2).

Recently, users have demanded display devices that are high in power saving effect (energy conservation effect).

The luminance of a display automatically adjusted according to the ambient brightness can advantageously reduce electricity consumption as compared with a display for which a high luminance is maintained irrespective of the ambient brightness.

Such automatic luminance adjustment however aims at realization of luminance at which a user feels it easy to see the display relative to the ambient brightness. As a consequence, automatic luminance adjustment according to the ambient brightness does not achieve a considerable power saving effect.

For this reason, high power saving effect cannot be achieved simply by switching on and off automatic adjustment as in the related art disclosed in the below Patent References 1 and 2.

Namely, techniques disclosed in Patent Reference 1 and 2 relates to simple selection between two modes (luminance control modes). With this configuration, if the user determines a desired luminance at which the user feels it easiest to see when the display is not in an automatic luminance adjustment mode, the user has to under go a complex OSD operation including a number of steps to change the desired luminance to low luminance which brings high power saving effect, thereby causing considerable inconvenience to the users.

Meanwhile, if luminance low enough to achieve high power saving effect is set for a display when the display is not in an automatic luminance adjustment mode, a user wishing to increase the determined luminance because bright surroundings hinder the user from comfortably viewing the display or for some other reason also has to undergo an OSD operation, which causing inconvenience to the user.

[Patent Reference 1] Japanese Patent Application Laid-Open No. 2004-117944

[Patent Reference 2] Japanese Patent Application Laid-Open No. 2000-330542

### SUMMARY OF THE INVENTION

With the foregoing problems in view, the object of the present invention is to provide a display device and a display system with which convenience of the user adjusting luminance of a display can be improved and in which a luminance control mode can be easily switched to that with high power-saving effect.

To attain the above object, as a first generic feature, there is provided a display device comprising: a display unit; a sensor for detecting an ambient luminance of the display unit; a luminance control unit for controlling a luminance of the display unit in a luminance control mode selected from a first luminance control mode in which the luminance of the display unit is changed in terms of the ambient luminance detected by the sensor, a second luminance control mode in which the luminance of the display unit is maintained at a predetermined luminance that has been previously determined and a third luminance control mode in which the luminance of the display unit is maintained at a minimum luminance; a first operating unit being operated to change the luminance control mode, in which the luminance control unit currently controls the luminance of the display unit; and a change controlling unit for changing the luminance control mode, in which the luminance control unit currently controls the luminance of the display unit, responsive to operating the first operating unit.

As a preferable feature, the change controlling unit may change the luminance control mode into the first luminance control mode, the second luminance control mode and the third luminance control mode one after another in predetermined order each time the first operating unit is operated.

As another preferable feature, the display device may further comprise a mode display controlling unit, and responsive to operating the first operating unit for the first time, the change controlling unit may maintain the luminance control mode, in which the luminance of the display unit is currently controlled, and the mode display controlling unit may display information of the luminance control mode maintained by the changed controlling unit on the display unit.

As an additional preferable feature, each time the first operating unit is operated for the second and the subsequent times, the change controlling unit may change the luminance control mode to the first luminance control mode, the second luminance control mode and the third luminance control mode one after another in predetermined order.

As a further preferable feature, if the change controlling unit changes the luminance control mode to one of the first luminance control mode, the second luminance control mode and the third luminance control mode, the mode display controlling unit may display information of the one luminance control mode, in which the luminance of the display unit is controlled after the changing, on the display unit.

As a still further preferable feature, when the luminance control unit controls the luminance of the display unit in the third luminance control mode, the luminance control unit may determine the minimum luminance on the basis of the ambient luminance detected by the sensor.

As a still further preferable feature, the display device may further comprise a second operating unit being operated to change the luminance of the display unit, and if the second operating unit is operated while the luminance controlling unit controls the luminance of the display unit in the first luminance control mode or in the third luminance control mode, the change controlling unit may change the luminance control mode, in which the luminance controlling unit controls the luminance of the display unit, into the second luminance control mode.

As a still further preferable feature, if the luminance controlling unit may control the luminance of the display unit in the second luminance control mode, the luminance controlling unit may change the predetermined luminance according to operating the second operating unit.

As a second generic feature to achieve the above object, there is provided a display system comprising: a display unit; an outputting unit for outputting a display signal; a display control unit for displaying the contents corresponding to the display signal output by the outputting unit on the display unit; a sensor for detecting an ambient luminance of the display unit; a luminance control unit for controlling a luminance of the display unit in a luminance control mode selected from a first luminance control mode in which the luminance of the display unit is changed in terms of the ambient luminance detected by the sensor, a second luminance control mode in which the luminance of the display unit is maintained at a predetermined luminance that has been previously determined and a third luminance control mode in which the luminance of the display unit is maintained at a minimum luminance; a first operating unit being operated to change the luminance control mode, in which the luminance control unit currently controls the luminance of the display unit; and a change controlling unit for changing the luminance control mode, in which the luminance control unit currently controls the luminance of the display unit, responsive to operating the first operating unit.

As a preferable feature, the change controlling unit may change the luminance control mode into the first luminance control mode, the second luminance control mode and the third luminance control mode one after another in predetermined order each time the first operating unit is operated.

As a third generic feature to attain the above object, there is provided a computer-readable recording medium in which a luminance adjustment program for adjusting a luminance of a display unit included in a display device also having a sensor for detecting an ambient luminance of the display unit is stored, wherein the program instructs a computer to function as: a luminance control unit for controlling a luminance of the display unit in a luminance control mode selected from a first luminance control mode in which the luminance of the display unit is changed in terms of the ambient luminance detected by the sensor, a second luminance control mode in which the luminance of the display unit is maintained at a predetermined luminance that has been previously determined and a third luminance control mode in which the luminance of the display unit is maintained at a minimum luminance; and a change controlling unit for changing the luminance control mode, in which the luminance control unit currently controls the luminance of the display unit, responsive to operating an operating unit which is operated to change the luminance control mode.

With this configuration of the present invention, the luminance controlling unit controls the luminance of the display unit in one of the first, the second and the third luminance control modes and the changing controlling section changes a luminance control mode of the luminance controlling unit responsive to an operation of the first operating unit (the operating unit). As a result, the user can change a luminance control for the display device into the third luminance control mode that is extremely high in power saving effect simply by operating a single unit of the first operation unit. In other words, the user can switch luminance control into a mode which achieves high power saving effect with ease.

Further, a simple operation of depressing a single unit of the first operating unit selects one of the three luminance control modes so that the convenience for users can be further enhanced.

The selectable three modes are the first, the second, and the third luminance control modes; the user may select the first luminance control mode if the user wishes the display to match the ambient brightness; the user may select the second luminance control mode if the user wishes the display to be at a predetermined luminance which user feels easiest to see; and the user may select the third luminance control mode if the user desires a high power-saving effect. The present invention can realize luminance control modes that users desire simply by depressing a single operating unit of the first operating unit and thereby solve the problems of the above related technique. Consequently, convenience for users can be drastically improved.

The three luminance control modes are alternated in predetermined order each time the first operating unit is operated, the user can switch luminance control to a desired luminance control with extreme ease and user convenience can be enhanced.

Upon depressing the first operating unit for the first time, the luminance controlling unit maintains the current luminance control mode and the mode display controlling section controls information of the current luminance control mode. With this configuration, the user can firstly grasp the current luminance control mode by operating the first operating unit and easily judge whether or not the current luminance control mode should be changed to another luminance control mode. In addition, the user can also grasp the number of operation of the first operating unit required for changing to a desired luminance control mode with ease, and convenience for the user can be therefore enhanced.

Further, since the mode display controlling unit displays information of a luminance control mode after the changing on the display, the user can grasp the new luminance control mode as a result of the changing at a glance and the convenience of the user can be improved.

Still further, since the minimum luminance for the third luminance control mode of the luminance controlling unit is determined according to the ambient brightness detected by the sensor, the present invention can prevent the visibility of the display unit that has been changed into the third luminance control mode from large impairments because the third luminance controlling mode realizes displaying in accordance with the ambient brightness as changing into the third luminance control mode, concurrently maintaining the effective result that a luminance control mode with high power-saving effect can be easily selected.

As described above, if the second operating unit is operated while the luminance controlling unit controls the luminance of the display unit in the first luminance control mode or in the third luminance control mode, the change controlling unit changes the luminance control mode, in which the luminance controlling unit controls the luminance of the display unit, into the second luminance control mode. With this configuration, the user can vary the current luminance simply by operating the second operating unit.

At that time, the luminance controlling section additionally varies the luminance predetermined for the second luminance controlling mode whereby the convenience to the user can be further improved.

Other objects and further features of the present invention will be apparent from the following detailed description when read in conjunction with the accompanying drawings.

### BRIEF DESCRIPTION OF THE DRAWINGS

FIG. 1 is a block diagram schematically showing a configuration of a display system according to an embodiment of the present invention;

FIG. 2 is a diagram illustrating a front appearance view of a display device of the embodiment of the present invention;

FIG. 3 is a diagram explaining the order in which a change controlling unit of a display device changes a luminance control mode in the display system according to the embodiment of the present invention;

FIG. 4 is a flow diagram showing a succession of procedural steps performed by a luminance controlling unit of the display device of the display system according to the embodiment in order to control the luminance of a display unit in eco-auto mode;

FIG. 5 is a flow diagram showing a succession of procedural steps performed by the luminance controlling unit in order to control the luminance of a display unit in the eco-auto mode;

FIGS. 6 and 7 are diagrams showing examples of automatic adjustment of the luminance of the display unit in the eco-auto mode by the luminance controlling unit according to the embodiment;

FIG. 8 is a diagram showing an example of a predetermined luminance value in the eco-off mode and the minimum luminance in the eco-on mode both of which are determined by the luminance controlling unit according to the embodiment; and

FIG. 9 is a flow diagram showing a succession of procedural steps performed in the display unit of the display system according to the embodiment.

### DESCRIPTION OF THE PREFERRED EMBODIMENTS

Hereinafter, an embodiment of the present invention will now be described with reference to the accompanying drawings.

### [1] An Embodiment

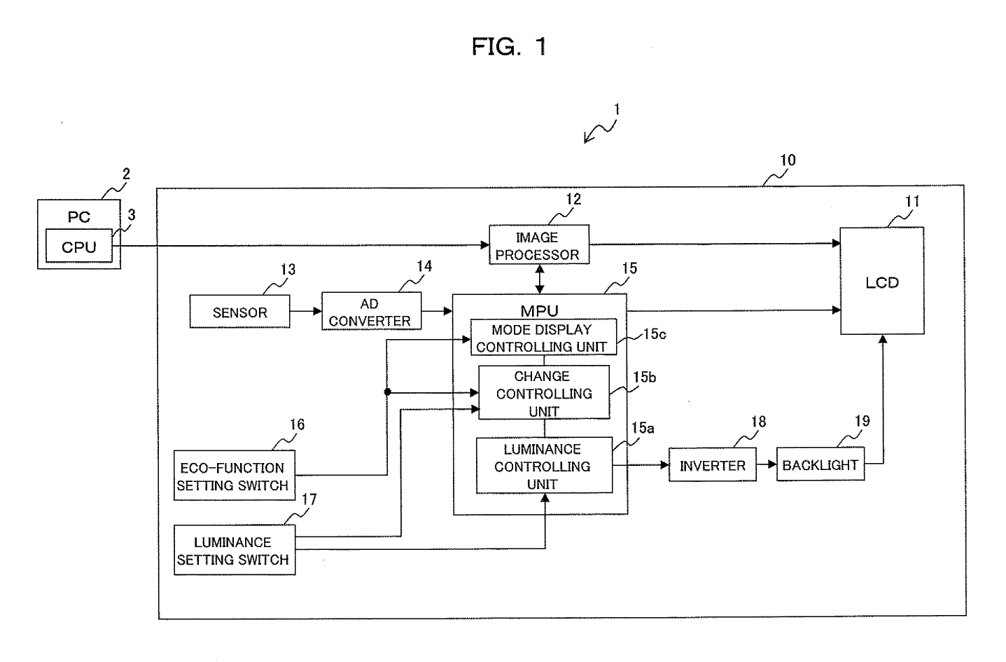

First of all, display system 1 according to an embodiment will now be described with reference to block diagram FIG. 1. As shown in FIG. 1, display system 1 is formed by a personal computer (“PC” in the drawing, hereinafter referred to as “PC” also in the specification) 2 and a display device 10. PC 2 includes a CPU (Central Processing Unit; an outputting unit) 3 that creates image signals (display signals) and outputs the created image signals to the display device 10.

Display device 10 according to an embodiment of the present invention includes display unit (e.g., a LCD (Liquid Crystal Display, denoted as “LCD” in the drawing) 11, image processor (a display controlling unit) 12, sensor 13, AD (Analog/Digital) converter 14, MPU (Micro Processing Unit) 15, eco-function setting switch (a first operating unit, herein after referred to as an eco button) 16, luminance setting switch (a second operating unit, hereinafter a luminance setting button) 17, inverter 18 and backlight 19.

Display unit 11 displays an image and others based on the image signals output by CPU 3 of PC 2 thereon.

Image processor 12 displays the image corresponding to the image signals output by CPU 3 of PC 2, in other words, controls display based on image signals on the display unit 11.

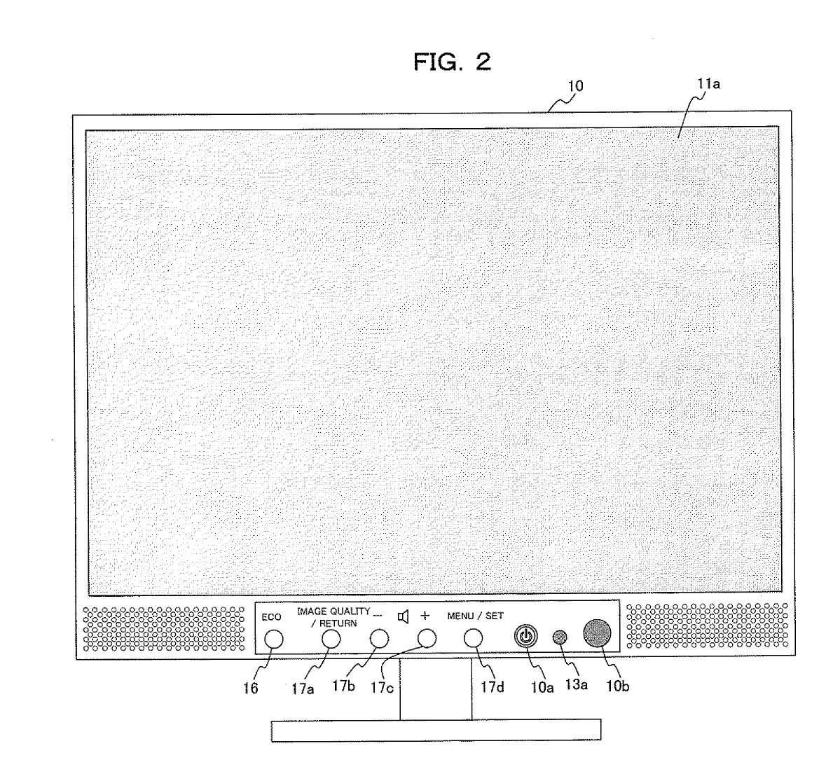

Sensor 13 detects (measures) an ambient luminance (brightness) of display device 10 and includes, for example, a light receiver 13a, which receives ambient light of the display device 10, arranged at the front side of display device 10 as shown in FIG. 2.

In FIG. 2, reference number 10a represents a power switch (button), reference number 10b represents a light receptor to receive operation signals from a remote control with which operation in display device 10 is remote-controlled, and reference number 11a represents a screen of the display unit 11.

AD converter 14 converts an analog signal indicating an intensity of light detected by sensor 13 to a digital signal and sends the digital signal to MPU 15.

MPU 15 controls the luminance (brightness) of display unit 11 on the basis of inputs from sensor 13 (specifically AD converter 14), eco button 16, and luminance setting button 17, and includes luminance controlling unit 15a, changing controlling unit 15b, and mode display controlling unit 15c.

Luminance controlling unit 15a controls luminance of display unit 11 in one luminance control mode among the eco-auto mode (a first luminance control mode) in which the luminance of display unit 11 is changed (automatically adjusted) according to the ambient luminance of display unit 11 which ambient luminance is detected by sensor 13, the eco-off mode (a second luminance control mode) in which the luminance of the display unit 11 is maintained at a predetermined luminance, and the eco-on mode (a third luminance control mode) in which the luminance of the display unit 11 is maintained at a minimum (lowest) luminance previously determined.

Changing controlling unit 15b changes a luminance control mode in which luminance controlling unit 15a controls the luminance of display unit 11 responsive to the operation (here, press) of eco button 16. Specifically, each time the user operates eco button 16 (in the illustrated example, each of operations for the second and the subsequent times as explained below), changing controlling unit 15b switches the luminance control mode of luminance controlling unit 15a to one of the three luminance control modes in the predetermined order.

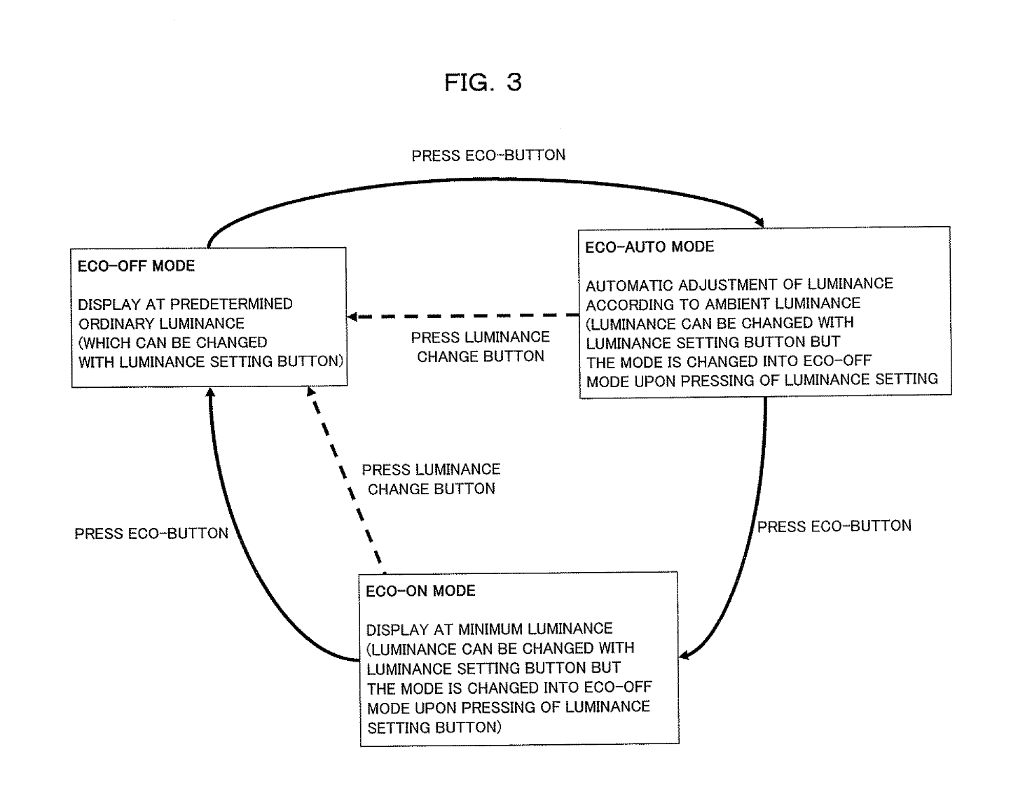

For example, changing controlling unit 15b switches, as shown in FIG. 3, a luminance control mode of luminance controlling unit 15a in the order of eco-off mode, eco-auto mode and eco-on mode each time eco button 16 is depressed.

However, when eco button 16 is depressed for the first time (after a predetermined time period has passed since the preceding operation on eco button 16), the changing controlling unit 15b does not change the luminance control mode of the luminance controlling unit 15a. In other words, luminance controlling unit 15a maintains the luminance control mode at that time (i.e., the current mode) if eco button 16 is depressed for the first time.

Further in short, the luminance control mode is switched in predetermined order as shown in FIG. 3 when eco button 16 is depressed for the second and the subsequent times.

In addition, if luminance setting button 17 is depressed by the user when the luminance controlling unit 15a controls the luminance of the display unit 11 in the eco-auto mode or the eco-on mode, changing controlling unit 15b switches the luminance control mode by the luminance controlling unit 15a to the eco-off mode.

Even if the user depresses luminance setting button 17 when the luminance controlling unit 15a is in the eco-off mode, the changing controlling unit 15b does not change the luminance control mode of the luminance controlling unit 15a, which changes the luminance that is to be set for the eco-off mode in accordance with the press of luminance setting button 17.

Mode display controlling unit 15c displays information about the current luminance control mode, in which the luminance controlling unit 15a controls the luminance of display unit 11, on display unit 11 responsive to eco button 16 being pressed.

Specifically, upon pressing eco button 16 for the first time, mode display controlling unit 15c displays the name (i.e., one of three modes of “eco-auto mode”, “eco-off mode” and “eco-on mode”) of the luminance control mode currently maintained by luminance controlling unit 15a on display unit 11.

Further, if eco button 16 is depressed for the second and the subsequent times, changing controlling unit 15b changes the luminance control mode of the luminance controlling unit 15a and mode display controlling unit 15c then displays the name of the luminance control mode after the change on display unit 11.

Eco button 16 is operated (depressed) by the user with the intention of changing the luminance control mode managed by luminance controlling unit 15a as described above, and is installed on, for example, the front side of the display device 10 as shown in FIG. 2.

As described above, luminance setting button 17 is operated by a user intending to change luminance of display unit land specifically take the form of buttons with reference numbers 17a-17d in FIG. 2 arranged on the front side of display device 10, for example.

Namely, operation buttons 17a-17d shown in FIG. 2 function as luminance setting button 17, and are operated by the user when the user intends to change the luminance of display unit 11 in the eco-off mode and to set and adjust various properties such as a hue, the positioning, contrast, distortion and the power supply of display unit 11, via OSD (On Screen Display).

Inverter 18 converts a luminance control signal which luminance controlling unit 15a of MPU 15 issues to control the luminance of display unit 11 into an analog signal and sends the analog signal to backlight 19.

Backlight 19 is prepared for a LCD in order to directly determine the luminance of display unit 11. In other words, the luminance of display unit 11 is determined by backlight 19.

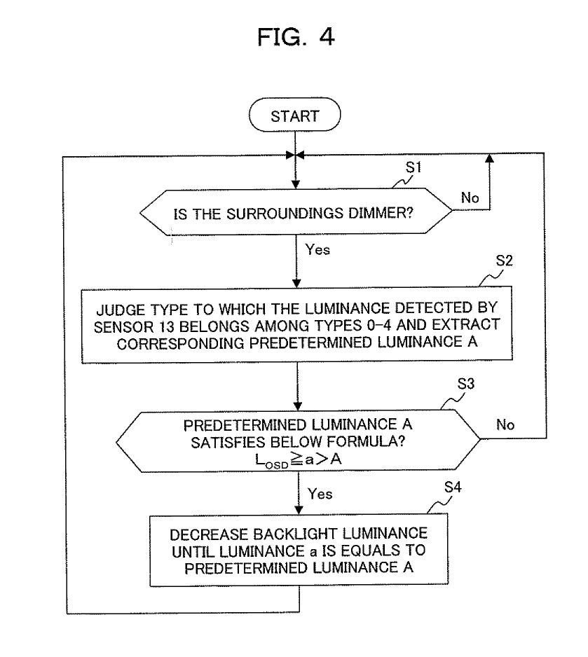

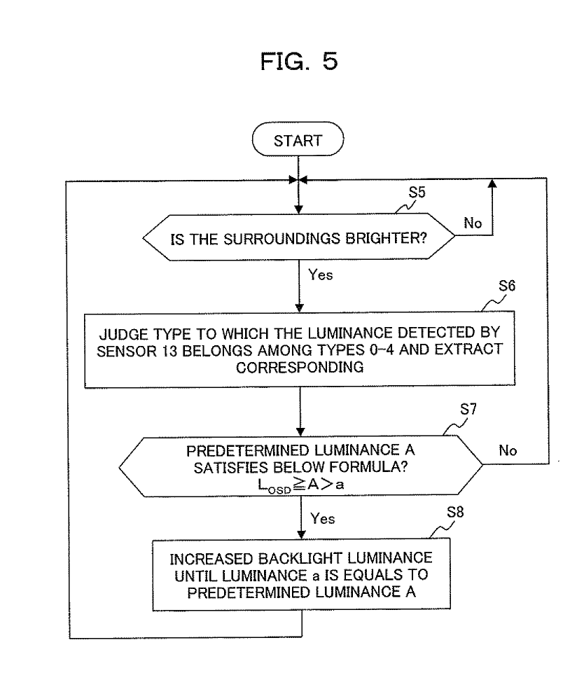

Here, description is made in relation to successions of procedural steps performed to control the luminance in the eco-auto mode by luminance controlling unit 15a of the MPU 15 with reference to a flow diagram (steps S1-S4) shown in FIG. 4 and a flow diagram (steps S5-S8) shown in FIG. 5.

In the eco-auto mode in FIGS. 4 and 5, the luminance of display unit 11 is automatically adjusted according to a desired luminance L_{OSD} set on OSD by the user operating operation buttons 17a-17d with reference to a setting screen on display unit 11 and the ambient brightness.

The procedural steps in FIG. 4 are carried out when the surroundings become dimmer in luminance during the eco-auto mode of luminance controlling unit 15a; and those in FIG. 5 are performed when the surroundings becomes brighter during the eco-auto mode of the luminance controlling unit 15a.

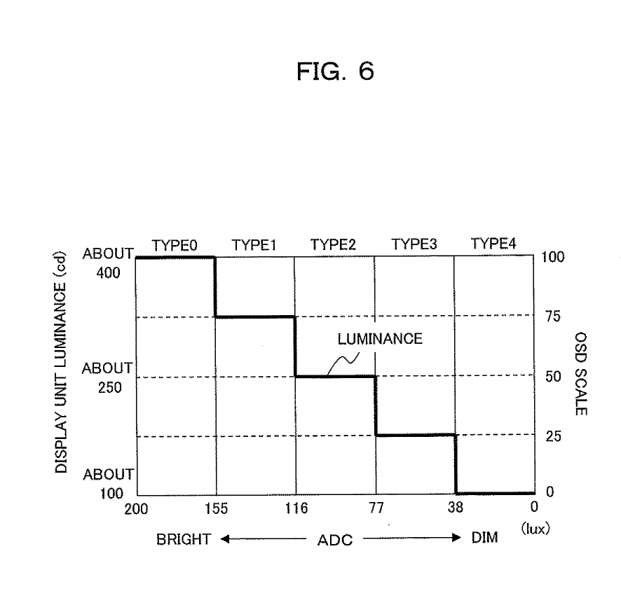

First of all, luminance controlling unit 15a classifies brightness of the surroundings of display unit 11 into five types of TYPE 0 to TYPE 4 (see FIG. 6 to be detailed below, in the illustrated example, the zone of TYPE 0 concerns luminance of 155 lux or higher; the zone of TYPE 1 concerns luminance of 116 lux or higher and lower than 155 lux; the zone of TYPE 2 concerns luminance of 77 lux or higher and lower than 116 lux; the zone of TYPE 3 concerns luminance of 38 lux or higher and lower than 77 lux; and the zone of TYPE 4 concerns the luminance lower than 38 lux), and retains predetermined luminance A for each of TYPE 0 to TYPE 4 in advance.

As shown in FIG. 4, on the basis of the ambient brightness detected by sensor 13, luminance controlling unit 15a firstly judges whether or not the surroundings of display unit 11 are dimmer in brightness (step S1).

For example, sensor 13 samples ambient luminance at intervals of a predetermined time period (e.g., 100 ms), and luminance controlling unit 15a regards the average of the detecting (measurement) results (ADC values output from AD converter 14) obtained by the detecting (measurement) over a number of times (e.g., four times) as a detected value (i.e., the ambient luminance detected by sensor 13). If the difference (decrease) of the current detected value from the previous detected value retained in the luminance controlling unit 15a is larger than a predetermined value and the same results are continuously obtained, luminance controlling unit 15a judges that the surroundings become dimmer in brightness (YES route in step S1), further judges which TYPE the detected ambient brightness is from among TYPES 0-4, and extracts the predetermined luminance A for the type that the detected ambient brightness is judged to be in (step S2).

On the other hand, luminance controlling unit 15a judges that the surroundings do not become dimmer in brightness (No route in step S1), and the procedure does not move to step S2.

In succession, luminance controlling unit 15a judges whether or not the predetermined luminance A extracted in step S2, the current luminance a of display unit display unit 11, and the desired luminance L_{OSD} satisfy following formula (1) (step S3).

L_{OSD}≧a>A (1)

If above formula (1) is not established (No route in step S3), luminance controlling unit 15a returns the procedural steps to step S1.

On the other hand, if above formula (1) is established (Yes route in step S3), luminance controlling unit 15a lowers the luminance of backlight 19 until the luminance a of display unit 11 comes to equal the predetermined luminance A (step S4). The procedure then returns to step S1 after the luminance a becomes equal to the predetermined luminance.

As described above, if the surroundings become dimmer during the eco-auto mode, luminance controlling unit 15a lowers (dims) the luminance of display unit 11 according to the dimming surroundings.

Here, description is made in relation to a succession of procedural steps performed as the surrounding becomes brighter during the eco-auto mode of luminance controlling unit 15a with reference to flow diagram FIG. 5. On the basis of the ambient brightness detected by sensor 13, luminance controlling unit 15a firstly judges whether or not the surroundings of display unit 11 are brighter in brightness (step S55).

In the present example, if the difference (increase) of the current detected value calculated in the manner described above from the previous detected value is larger than a predetermined value and such a difference is observed in number of successive times, luminance controlling unit 15a judges that the surroundings become brighter (Yes route in step S5). Further, luminance controlling unit 15a judges which TYPE the detected ambient brightness is in among TYPES 0-4, and extracts the predetermined luminance A for the type judged that the detected ambient brightness is in (step S6).

On the other hand, luminance controlling unit 15a judges that the surroundings do not become brighter in brightness (No route in step S5) and the procedure does not move to step S6.

In succession, the luminance controlling unit 15a determines whether or not the predetermined luminance A extracted in step S6, the current luminance a of display unit 11, and the desired luminance L_{OSD} establish the following formula (2) (step S7).

L_{OSD}≧A>a (2)

If above formula (2) is not established (No route in step S7), luminance controlling unit 15a returns the procedural steps to step S5.

On the other hand, if above formula (2) is established (Yes route in step S7), luminance controlling unit 15a increases the luminance of backlight 19 until the luminance a of display unit 11 comes to equal to the predetermined luminance A (step S8). The procedure returns to step S5 after the luminance a becomes equal to the predetermined luminance A.

As described above, if the surroundings become brighter during the eco-auto mode, luminance controlling unit 15a raises (brightens) the luminance of display unit 11 according to the brightening surroundings.

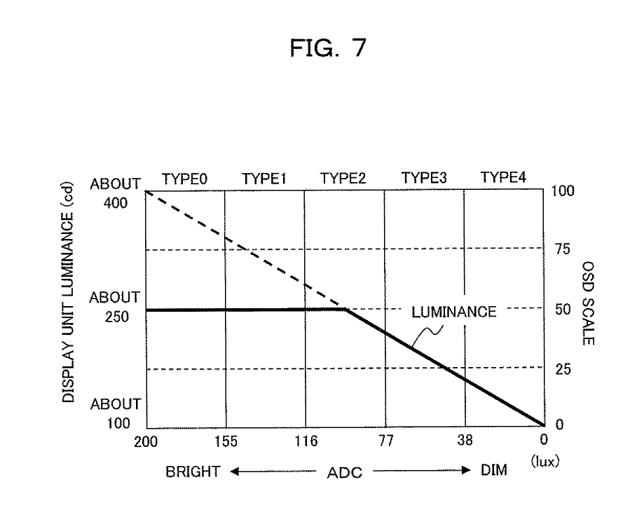

In the present invention, the specific manner of controlling the luminance (the manner of automatic controlling the luminance) in the eco-auto mode by luminance controlling unit 15a should by no means be limited to the above manner. Alternatively, the techniques disclosed in the above-described patent references 1 and 2 may be applied to the luminance control. Further alternatively, the luminance control may be carried out such that the luminance of display unit 11 is controlled to be constant for each of TYPES 0-4 defined in terms of the ambient brightness as shown in FIG. 6, or such that the luminance of display unit 11 is not raised higher than a value previously set by the user as shown in FIG. 7 even the surroundings become brighter. In FIGS. 6 and 7, a left y-axis represents the luminance (cd) of a display and a right y-axis represents a scale (OSD scale) used to adjust the luminance in OSD setting corresponding to the luminance represented by the left y-axis.

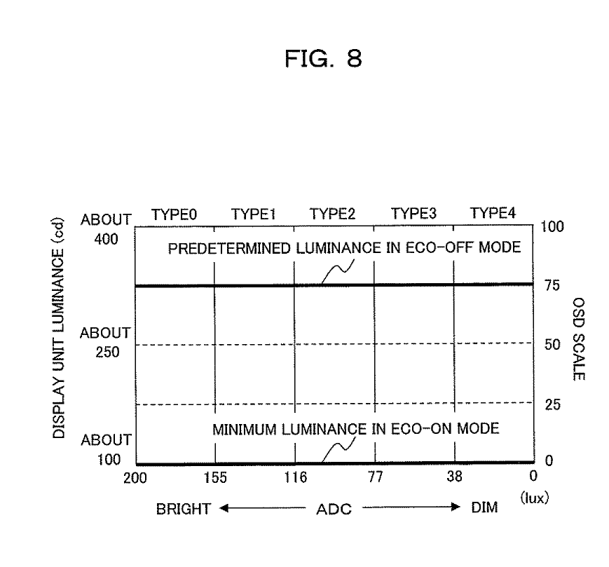

When luminance controlling unit 15a controls the luminance in the eco-off mode, luminance controlling unit 15a, as shown in FIG. 8, constantly controls the luminance of display unit 11 at a desired luminance (here the luminance is a value corresponding to OSD scale “75”) set by the user operating luminance setting button 17 via OS irrespective of the ambient brightness.

Further as shown in FIG. 8, luminance controlling unit 15a controls the luminance of display unit 11 in the eco-on mode, luminance controlling unit 15a constantly controls the luminance of display unit 11 at the minimum luminance (here, the luminance is a value corresponding to OS scale 0) irrespective of the ambient brightness. At that time, luminance controlling unit 15a sends inverter 18 a luminance control signal, which encourages inverter 18 to flow the minimum electric current to realize the minimum luminance to backlight 19.

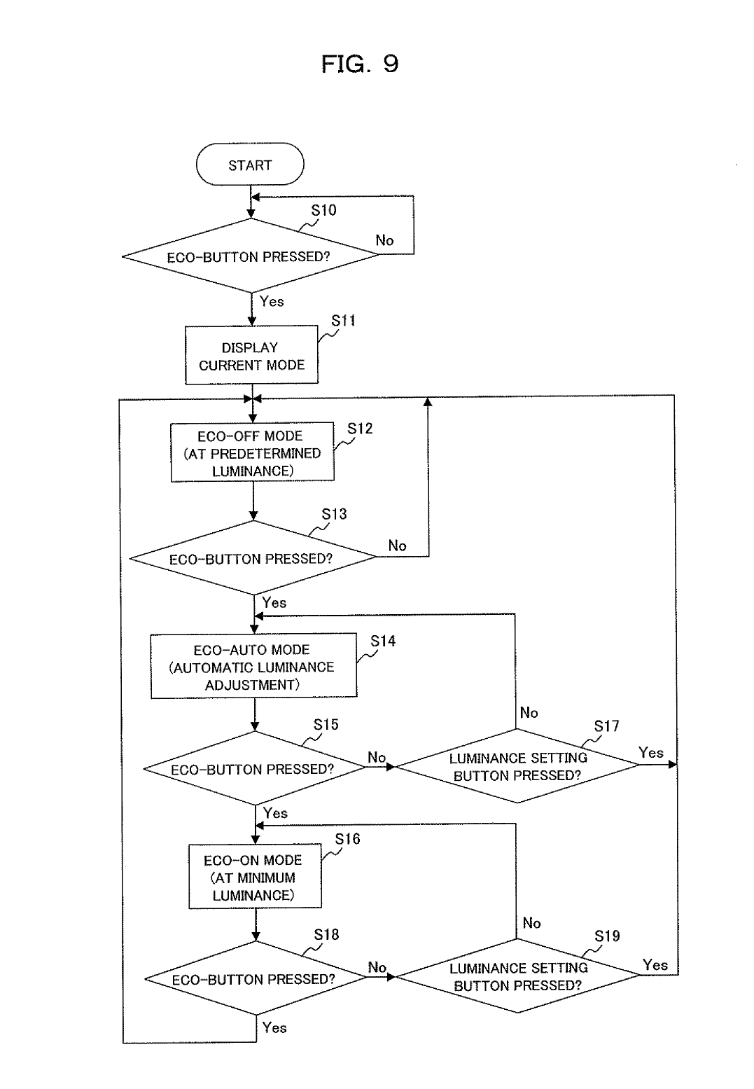

Description is made in relation to a succession of procedural steps performed for luminance control in display device 10 of the present invention with reference to flow diagram FIG. 9 (steps S10-S19) In the example shown in FIG. 9, luminance controlling unit 15a controls the luminance in the eco-off mode at the beginning of the procedural steps (at the present).

When the user depresses eco button 16 for the first time (Yes route in step S10), mode display controlling unit 15c displays the name (here “eco-off mode”) of the current mode (the current luminance control mode) on display unit 11 (step S1) and luminance controlling unit 15a maintains the current eco-off mode without switching to another mode (step S12).

The procedures of step S1 and after are not carried out, of course, if eco button 16 is not depressed by the user (No route in step S10).

Then, if the user further depresses eco button 16 (here, for the second time) (Yes route in step S13), changing controlling unit 15b switches the luminance control mode of luminance controlling unit 15a from the eco-off mode to the eco-auto mode (step S14).

If user's second-time depress of eco button 16 does not occur (No route in step S13), the procedural steps do not move to above step S14. Specifically, if the user does not depress eco button 16 for the second time for a predetermined time period after the first-time press, luminance controlling unit 15a fixes the luminance control mode for the eco-off mode and mode display controlling unit 15c terminates control over the display of “eco-off mode” on display unit 11. Consequently, the display of “eco-off mode” on display unit 11 vanishes.

Next, the user further depresses eco button 16 (here for the third time) (Yes route in step S15), changing controlling unit 15b switches the luminance control mode from the eco-auto mode to the eco-on mode (step S16).

On the other hand, while luminance controlling unit 15a is in the eco-auto mode, if the user does not depress eco button 16 (No route in step S15) but depresses luminance setting button 17 (Yes route in step S17), changing controlling unit 15b switches the luminance control mode by luminance controlling unit 15a from the eco-auto mode to the eco-off mode and luminance controlling unit 15a concurrently varies the predetermined luminance for the eco-off mode in accordance with the press of luminance setting button 17 (step S12).

At that time, MPU 15 displays the OSD setting screen on the display unit 11. Further, the then predetermined luminance of luminance controlling unit 15a is obtained by changing the luminance when the press of luminance setting button 17. In other words, luminance controlling unit 15a regards the pressing of luminance setting button 17 in step S17 as a change for the luminance at which luminance controlling unit 15a controls the luminance of display unit 11 when the user depresses luminance setting button 17 but not as a change for the luminance predetermined originally set for the eco-off mode whereby the changed luminance is regarded as the new predetermined luminance. As a result, the user can set the luminance of display unit 11 to a desired value directly from the current luminance, and the convenience of the user can be thereby improved.

A press of luminance setting button 17b (“−” button) in FIG. 2 decreases the luminance and a press of luminance setting button 17c (“+” button) increases the luminance, so that the two buttons 17b and 17c serve as luminance setting button 17.

It is natural to say that, if the user does not depress eco button 16 (NO route in step S15) or luminance setting button 17 (No route in step S17), luminance controlling unit 15a keeps luminance control in the eco-auto mode (step S14). Specifically, if the user does not further depress eco button 16 within a predetermined time period since the user has depressed eco button 16 in step S13, luminance controlling unit 15a fixes the luminance control mode for the eco-auto mode. At that time, mode display controlling unit 15c further terminates control of displaying of “eco-auto mode” on display unit 11 which control started in step S14 to turn off the display of “eco-auto mode” on display unit 11.

After changing controlling unit 15b changes the luminance control mode of luminance controlling unit 15a into the eco-on mode (step S16), user's press of luminance setting button 17 (Yes route in step S19) without a press of eco button 16 (No route in step S18) causes changing controlling unit 15b to change the luminance control mode of luminance controlling unit 15a from the eco-on mode to the eco-off mode and luminance controlling unit 15a changes the predetermined luminance for the eco-off mode in accordance with the press of luminance setting button 17 as described above (step S12).

Needless to say, if the user does not depress eco button 16 (NO route in step S18) or luminance setting button 17 (No route in step S19), luminance controlling unit 35a holds the eco-on mode as the luminance control mode (step S16). Specifically, if the user does not further depress eco button 16 within a predetermined time period since the user has depressed eco button 16 in above step S15, luminance controlling unit 15a fixes the luminance control mode for the eco-on mode. At that time, mode display controlling unit 15c further terminates control of displaying of “eco-on mode” on display unit 11 which control started in step S16 to turn off the display of “eco-on mode” on display unit 11.

On the other hand, if the user depresses eco button 16 (Yes route in step S18) after changing controlling unit 15b changes the luminance control mode of luminance controlling unit 15a to the eco-on mode (step S16), changing controlling unit 15b changes the luminance control mode of luminance controlling unit 15a from the eco-on mode to the eco-off mode (step S12). After that, the succession of procedural steps S12-S19 is repeated in response to the user pressing eco button 16 and luminance setting button 17.

During the procedure of above steps S12-S19, each time changing controlling unit 15b switches the luminance control mode of luminance controlling unit 15a, mode display controlling unit 15c displays the name of the luminance control mode after the switching on display unit 11.

As detailed above, in display system 1 (display device 10), luminance controlling unit 15a controls the luminance of display unit 11 in the three modes of eco-auto mode, eco-off mode and eco-on mode, and changing controlling unit 15b changes the luminance control mode of luminance controlling unit 15a in response to a user depressing eco button 16. With this configuration, depressing of only eco button 16 can switch the luminance control mode to the eco-on mode that is high in power save effect, and therefore that allows the user to switch the luminance control mode to the eco-on mode high in power save effect with extreme ease.

In addition, one from the three modes can be selected simply by depressing single eco button 16 whereby the convenience of the user is enhanced.

The selectable three modes are the eco-auto mode, the eco-off mode and the eco-on mode; the user may select the eco-auto mode if the user desires a display matching the ambient brightness; the user may select the eco-off mode if the user desires a display at a predetermined luminance at which the user feels it is easiest to see; and the user may select the eco-auto mode if the user desires a high power-saving effect. The present invention can realize luminance control modes users desire simply by depressing a single button of eco button 16 and solves the problems of the above related technique.

Since changing controlling unit 15b alternates the three luminance control modes of LUMINANCE controlling unit 15a in predetermined order each time eco button 16 is depressed (in the illustrated example, for the second and the subsequent times), the user more conveniently switches the luminance control mode to the desired mode with extreme ease.

Upon depressing of eco button 16 for the first time, changing controlling unit 15b does not change the luminance control mode of luminance controlling unit 15a so that luminance controlling unit 15a holds the current luminance control mode, and mode display controlling unit 15c displays the name of the current luminance control mode as information about the current luminance control mode on display unit 11. With this configuration, the user can grasp the current luminance control mode by the first press of eco button 16 to easily judge whether or not a switch to another luminance control mode is required and to grasp the number of times of pressing eco button 16 that are required for a switch to the desired luminance control mode, thereby improving the convenience of users.

In addition, if changing controlling unit 15b switches the current luminance control mode of luminance controlling unit 15a to another luminance control mode, mode display controlling unit 15c displays the name of the new luminance control mode on display unit 11. With reference to such a display, the user can grasp the new luminance control mode resulting from the switching at a glance, and the convenience of the user can be improved.

If luminance setting button 17 is operated (depressed) while the luminance controlling unit 15a controls the luminance of display unit 11 in the eco-auto mode or the eco-on mode, changing controlling unit 15b switches the current luminance control mode of luminance controlling unit 15a to the eco-off mode to cause the user to easily vary the current luminance of display unit 11.

In addition, since luminance controlling unit 15a then changes the predetermined luminance for the eco-off mode in accordance with the press of luminance setting button 17, the user can subsequently display images and letters on display unit 11 at a desired luminance to which the predetermined luminance has been switched by depressing luminance setting button 17 into the eco-off mode into which the luminance control mode is changed by depressing eco button 16 and the like, thereby enhancing convenience of the user.

(2) Others:

The present invention should by no means be limited to the foregoing embodiment, and various changes or modifications may be suggested without departing from the gist of the invention.

For example, in the above embodiment, luminance controlling unit 15a in the eco-on mode controls the luminance of display unit 11 at the minimum luminance value irrespective of the ambient brightness. The present invention should by no means be limited to this manner. Alternatively, luminance controlling unit 15a in the eco-on mode may determine the minimum luminance value according to the ambient brightness detected by sensor 13.

In detail, luminance controlling unit 15a previously retains the minimum luminance value for each of TYPES 0-4 described above with reference to FIG. 8, and upon depressing of eco button 16 by the user with intention to switch to the eco-on mode, judges to which range (among TYPES 0-4) the ambient brightness detected by sensor 13 belongs and constantly controls the luminance of display unit 11 at the minimum luminance value predetermined for the corresponding range.

For example, if the ambient brightness when eco button 16 is pressed corresponds to TYPE 0, luminance controlling unit 15a controls the luminance of display unit 11 at the luminance corresponding to OSD scale “20” (see FIG. 8); when the ambient brightness corresponds to TYPE 1, luminance controlling unit 15a controls the luminance of display unit 11 at the luminance of OSD scale “15”; when the ambient brightness corresponds to TYPE 2, luminance controlling unit 15a controls the luminance of display unit 11 at the luminance of OSD scale “10”; when the ambient brightness corresponds to TYPE 3, luminance controlling unit 15a controls the luminance of display unit 11 at the luminance of OSD scale “5”; and when the ambient brightness corresponds to TYPE 4, luminance controlling unit 15a controls the luminance of display unit 11 at the luminance of OSD scale “0”.

In this alternative, while luminance controlling unit 15a is in the eco-on mode, the minimum luminance value is determined in accordance with the ambient brightness detected by sensor 13 (in other words, a larger luminance value is set as the minimum luminance value for a brighter ambient brightness step by step). With this configuration, a luminance control mode high in power save effect can be selected with ease similarly to the above-described embodiment and additionally, since display unit 11 is controlled at the minimum luminance value in accordance with the ambient brightness as switching to the eco-on mode, it is possible to prevent visibility of display unit 11 that has been switched to the eco-on mode from being largely impaired.

In the above embodiment, the user's first press of eco button 16 does not prompt changing controlling unit 15b to change the luminance control mode of luminance controlling unit 15a so that the current luminance control mode is maintained, to which the present invention should by no means be limited. Alternatively, changing controlling unit 15b may switch the current luminance control mode of luminance controlling unit 15a to another mode responsive to the first user's press of eco button 16, so that luminance controlling unit 15a changes the luminance control mode when the user depresses eco button 16 for the first time.

At that time, mode display controlling unit 15c displays the name of the new luminance control mode after the switching caused by the first press of eco button 16 on display unit display unit 11 and further displays the name of a new luminance control mode each time eco button 16 is depressed.

Further, the changing controlling unit 15b alternates the luminance control mode of luminance controlling unit 15a in order of the eco-off mode, the eco-auto mode and the eco-on mode each time eco button 16 is depressed in the above embodiment. Alternatively, the order in which the luminance control mode of luminance controlling unit 15a is switched by changing controlling unit 15b each time eco button 16 is depressed is not limited on the present invention, but may at least be a predetermined fixed order.

Display system 1 of the above embodiment consists of display device 10 and PC 2, to which the present invention should by no means be limited. Any device may be connected to display device 10 as long as the device outputs image signals to display device 10. Further, PC 2 (or a device corresponding to PC 2 that outputs image signals) and display device 10 may be formed in one body, not in separated bodies.

Display unit 11 of the above embodiment is exemplified by a LCD, to which the present invention should by no means be limited. Any display luminance of which is varied can be used as display unit 11.

Further, the above embodiment assumes that eco button 16 initiates actions by being depressed, but eco button 16 of the present invention should by no means be limited to such a type. Alternatively, eco button 16 may be an operating device in the form of a dial or a slide control, and as a consequence, eco button 16 may be any form operatable by users.

In the above embodiment, buttons 17a-17d unitedly function as luminance setting button 17, but the present invention should by no means be limited to this. It is sufficient that at least one of buttons 17a-17d function as luminance setting button 17; for example, buttons 17a and 17d may be dedicated to OSD and button 17b (the “−” button) and button 17c (“+” button) may function as luminance setting button 17.

Still further, functions as luminance controlling unit 15a, changing controlling unit 15b and mode display controlling unit 15c may be realized by a computer (including a CPU, an information processing machine, and various terminals) executing a predetermined programs (luminance control program).

The program is provided in the form of being recorded in a computer-readable recording medium, such as a flexible disk, a CD (e.g., CD-ROM, CD-R, CD-RW), or a DVD (e.g., DVD-ROM, DVD-RAM, DVD-R, DVD-RW, DVD+R, DVD+RW). Further, a computer may read such a luminance control program from the recording medium and sends the read program to an internal or external memory to store for use. Further alternatively, the program may be recorded in a memory device (a recording medium), such as a magnetic disk, an optical disk or a magneto-optical disk, and is provided to the computer from the memory device through a communication path.

Here, a computer is a concept of a combination of hardware and an OS and means hardware which operates under control of the OS. Otherwise, if an application program operates hardware independently of an OS, the hardware corresponds to the computer. Hardware includes at least a microprocessor such as a CPU and means to read a computer (application) program recorded in a recording medium.

An application program functioning as the luminance control program includes program codes that prompt the computer of the above-described type to realize the functions of luminance controlling unit 15a, changing controlling unit 15b and mode display controlling unit 15c. Part of the functions can be realized by the OS not by the application program.

The recording medium used in the foregoing embodiment may be various computer-readable recording media such as an IC card, a ROM cartridge, a magnetic tape, a punch card, an internal storage unit (a memory such as RAM or RON) for a computer, an external storage unit, or a printing matter on which codes, such as bar codes, are printed, in addition to a flexible disk, a CD, a DVD, a magnetic disk, an optical disk and a magnet-optical disk above listed.

What is claimed is:

1. A display device comprising:
a display unit;
a sensor for detecting an ambient luminance of said display unit;
a luminance control unit for controlling a luminance of said display unit in a luminance control mode selected from a first luminance control mode in which the luminance of the display unit is changed in terms of the ambient luminance detected by said sensor, a second luminance control mode in which the luminance of said display unit is maintained at a predetermined luminance that has been previously determined and a third luminance control mode in which the luminance of said display unit is maintained at a minimum luminance;
a first operating unit being operated to change the luminance control mode, in which said luminance control unit currently controls the luminance of said display unit; and
a change controlling unit for changing the luminance control mode, in which said luminance control unit currently controls the luminance of said display unit, responsive to operating said first operating unit.

2. A display device according to claim 1, wherein said change controlling unit changes the luminance control mode into the first luminance control mode, the second luminance control mode and the third luminance control mode one after another in predetermined order each time said first operating unit is operated.

3. A display device according to claim 1, further comprising a mode display controlling unit,
wherein responsive to operating said first operating unit for the first time, said change controlling unit maintains the luminance control mode, in which the luminance of the display unit is currently controlled, and said mode display controlling unit displays information of the luminance control mode maintained by said changed controlling unit on said display unit.

4. A display device according to claim 3, wherein each time said first operating unit is operated for the second and the subsequent times, said change controlling unit changes the luminance control mode to the first luminance control mode, the second luminance control mode and the third luminance control mode one after another in predetermined order.

5. A display device according to claim 4, wherein if said change controlling unit changes the luminance control mode to one of the first luminance control mode, the second luminance control mode and the third luminance control mode, said mode display controlling unit displays information of the one luminance control mode, in which the luminance of said display unit is controlled after the changing, on said display unit.

6. A display device according to claim 3, wherein said mode display controlling unit displays, on said display unit, the name of the luminance control mode as the information of the luminance control mode.

7. A display device according to claim 1, when said luminance control unit controls the luminance of said display unit in the third luminance control mode, said luminance control unit determines the minimum luminance on the basis of the ambient luminance detected by said sensor.

8. A display device according to claim 1, further comprising a second operating unit being operated to change the luminance of the display unit,
wherein if said second operating unit is operated while said luminance controlling unit controls the luminance of said display unit in the first luminance control mode or in the third luminance control mode, said change controlling unit changes the luminance control mode, in which said luminance controlling unit controls the luminance of said display unit, into the second luminance control mode.

9. A display device according to claim 8, wherein if said luminance controlling unit control the luminance of said display unit in the second luminance control mode, said luminance controlling unit changes the predetermined luminance according to operating said second operating unit.

10. A display system comprising:
a display unit;
an outputting unit for outputting a display signal;
a display control unit for displaying the contents corresponding to the display signal output by said outputting unit on said display unit;
a sensor for detecting an ambient luminance of said display unit;
a luminance control unit for controlling a luminance of said display unit in a luminance control mode selected from a first luminance control mode in which the luminance of the display unit is changed in terms of the ambient luminance detected by said sensor, a second luminance control mode in which the luminance of said display unit is maintained at a predetermined luminance that has been previously determined and a third luminance control mode in which the luminance of said display unit is maintained at a minimum luminance;
a first operating unit being operated to change the luminance control mode, in which said luminance control unit currently controls the luminance of said display unit; and
a change controlling unit for changing the luminance control mode, in which said luminance control unit currently controls the luminance of said display unit, responsive to operating said first operating unit.

11. A display system according to claim 10, wherein said change controlling unit changes the luminance control mode into the first luminance control mode, the second luminance control mode and the third luminance control mode one after another in predetermined order each time said first operating unit is operated.

12. A display system according to claim 10, further comprising a mode display controlling unit,
wherein responsive to operating said first operating unit for the first time, said change controlling unit maintains the luminance control mode, in which the luminance of the display unit is currently controlled, and said mode display controlling unit displays information of the luminance control mode maintained by said changed controlling unit on said display unit.

13. A display system according to claim 12, wherein each time said first operating unit is operated for the second and the subsequent times, said change controlling unit changes the luminance control mode to the first luminance control mode, the second luminance control mode and the third luminance control mode one after another in predetermined order.

14. A display system according to claim 13, wherein if said change controlling unit changes the luminance control mode to one of the first luminance control mode, the second luminance control mode and the third luminance control mode, said mode display controlling unit displays information of the one luminance control mode, in which the luminance of said display unit is controlled after the changing, on said display unit.

15. A display system according to claim 12, wherein said mode display controlling unit displays, on said display unit, the name of the luminance control mode as the information of the luminance control mode.

16. A display system according to claim 10, when said luminance control unit controls the luminance of said display unit in the third luminance control mode, said luminance control unit determines the minimum luminance on the basis of the ambient luminance detected by said sensor.

17. A display system according to claim 10, further comprising a second operating unit being operated to change the luminance of the display unit,
wherein if said second operating unit is operated while said luminance controlling unit controls the luminance of said display unit in the first luminance control mode or in the third luminance control mode, said change controlling unit changes the luminance control mode, in which said luminance controlling unit controls the luminance of said display unit, into the second luminance control mode.

18. A display system according to claim 17, wherein if said luminance controlling unit control the luminance of said display unit in the second luminance control mode, said luminance controlling unit changes the predetermined luminance according to operating said second operating unit.

19. A computer readable recording medium in which a luminance adjustment program for adjusting a luminance of a display unit included in a display device also having a sensor for detecting an ambient luminance of said display unit is stored, wherein said program instructs a computer to function as:
a luminance control unit for controlling a luminance of said display unit in a luminance control mode selected from a first luminance control mode in which the luminance of the display unit is changed in terms of the ambient luminance detected by said sensor, a second luminance control mode in which the luminance of said display unit is maintained at a predetermined luminance that has been previously determined and a third luminance control mode in which the luminance of said display unit is maintained at a minimum luminance; and
a change controlling unit for changing the luminance control mode, in which said luminance control unit currently controls the luminance of said display unit, responsive to operating an operating unit which is operated to change the luminance control mode.

20. A computer-readable recording medium according to claim 19, wherein said change controlling unit changes the luminance control mode into the first luminance control mode, the second luminance control mode and the third luminance control mode one after another in predetermined order each time the operating unit is operated.
